(19) United States
(12) Patent Application Publication
(10) Pub. No.: US 2014/0104979 A1
(43) Pub. Date: Apr. 17, 2014

(54) Ground-Penetrating Tunnel-Detecting Active Sonar

(71) Applicant: STOLAR RESEARCH CORPORATION, Rio Rancho, NM (US)

(72) Inventors: Gerald L. Stolarczyk, Rio Rancho, NM (US); Larry G. Stolarczyk, Raton, NM (US); Richard B. Main, Newark, CA (US)

(73) Assignee: STOLAR RESEARCH CORPORATION, Rio Ranch, NM (US)

(21) Appl. No.: 14/133,056

(22) Filed: Dec. 18, 2013

Related U.S. Application Data
(63) Continuation-in-part of application No. 13/570,257, filed on Aug. 9, 2012.
(60) Provisional application No. 61/899,256, filed on Nov. 3, 2013.

(51) Int. Cl. G01S 15/89

(52) U.S. Cl. CPC G01S 15/89
USPC 367/7

(57) ABSTRACT

A ground-penetrating tunnel-detecting active sonar launches two different monotonic acoustic beams down into the ground from the surface. If the two separate monotonic acoustic waves arrive at a stress field, they will mix and produce a frequency difference heterodyne due to the inherent pressure nonlinearities in the solid medias. Any sonar returns are bandpass filtered so only an acoustic frequency difference heterodyne can pass through. The existence of a tunnel is revealed by the return of acoustic frequency difference heterodynes all coming from a more-or-less horizontal line of phase-delayed sources and directions. These phase differences can be derived from the vector values provided by the acoustic vector sensor. Three or more acoustic vector sensors on the surface can be used effectively to provide triangulations down to the tunnel to better estimate the tunnel track.

This Application claims benefit of U.S. Provisional Patent Application Ser. No. 61/899,256, filed Nov. 3, 2013. This Application also claims benefit of and is a continuation-in-part of U.S. patent application, Ser. No. 13/570,257, filed Aug. 9, 2012, and titled, ACOUSTIC HETERODYNE RADAR, by Larry G. Stolarczyk, et al. Such provisional and parent applications are incorporated herein by reference, in full.

### BACKGROUND

1. Field of the Invention

The present invention relates to sonar devices and methods, and more particularly to using the nonlinear stress fields in the rocks and soils enveloping tunnels caused by lithostatic and hydrostatic pressures to sonar-illuminate the course of any tunnels.

2. Description of the Prior Art

Knowing where tunnels are can be very important. Underground tunnels are often not where they are supposed to be, or where they are allowed to be. Sometimes their existence has been forgotten, and sometimes their construction has been illegal and deliberately conducted secret. In any event, finding them from the surface is economically useful, and more often necessary for safety, rescue, defense, and security.

Remote sensing into the earth to find, characterize, and image deeply buried objects and features has always been difficult. Ground penetrating radars have been developed that depend on measuring the delays, attenuations, and phase shifts imposed on deep reflections of radiowaves to characterize and image what lies beneath. Companies like Stolar, Inc. (Raton, N. Mex.) have gotten quite good at sorting out the carrier frequencies, modulation schemes, synchronous detection techniques, and antenna construction needed to look with radio signals deep into the earth to find coal deposits, mining hazards, trapped miners, and even smugglers' tunnels.

In general, objects need to contrast in some way with their surroundings in order to be “seen”. Active radars do this when they “light up” an area with radio transmissions to see if anything reflects the radio waves back. Active sonars do that too by sending out strong acoustic “pings” and then listen for echoes. Increases in the distance to the targets and decreasing degrees of reflectivity will both reduce the strength of any echoes that are returned. Increases in the distance to the targets also increases the delay times for the echo return. And determining the exact delay time can yield the range to the target if the speed of signal propagation is well understood.

Things that are already reflecting or emitting light, radio, or sound are even easier to spot. And because scanning for them does not require a transmitter pulse from the radar or sonar to be output, detecting such things can be surreptitious. Passive sonar works this way, as do photo, vibration, and motion detectors.

The depth range of ground penetrating radar (GPR) is limited by the electrical conductivity of the ground, the transmission frequencies, and the radiated powers. When conductivity increases, the penetration depth decreases because the electromagnetic energy is more quickly dissipated into heat, causing a loss in signal strength at depth.

Higher radio frequencies do not penetrate as well as do lower frequencies, but higher frequencies give better resolution. Optimal depth penetration is achieved in ice where the depth of penetration can reach several hundred meters. Good penetration is also possible in dry sandy soils, granite, limestone, concrete, and other massive dry materials. The depth of penetration can be as good as 15-meters. In moist and/or clay-laden soils and soils with high electrical conductivity, GPR penetration is sometimes only a few centimeters.

Acoustic waves can travel long distances and through great depths in the earth. This then makes the use of acoustic waves to scan for deeply buried tunnels very attractive, maybe even more so than using radiowaves. Soils that are not dielectric will attenuate high frequency radio waves very rapidly, such has no effect on acoustic waves.

Deep rock masses are subject to lithostatic pressures and stresses that result from the weight of the overburden and any tectonic stresses that were locked-in originally. When tunnels are bored through the ground, the original stresses will re-distribute and concentrate in an envelope around the new emptiness. Not being solids, these voids will not support any weight unless they are sealed and greatly pressurized. That usually isn't the case.

These new stresses in the rock are man-made and will be seen to concentrate around the tunnel cavities like tubes or sheaths. This makes them relatively easy to distinguish from natural structures. The stress magnitudes are a function of the in situ stress fields and the cross sectional profiles of the tunnel.

Biao Qiu, et al., reported their estimates of stress fields around underground openings in “Investigation Study of the Stress Field Surrounding a Well Bore and a Rectangular Tunnel”, West Virginia University, Department of Mining Engineering, that surround wellbores and tunnels at depth. They concluded for a well bore that the maximum horizontal, vertical, and shear stresses at a depth of twenty feet are about 15-PSI, 41-PSI, and 15-PSI, respectively, increasing to 40-PSI, 145-PSI, and 43-PSI at a depth of sixty feet. They further concluded for a rectangular tunnel that the maximum horizontal, vertical, and shear stresses at a depth of about twenty feet are 21-PSI, 42-PSI, and 14-PSI, respectively, increasing to 62-PSI, 26-PSI, and 46-PSI at a depth of sixty feet. Importantly, the stress concentration zones for all conditions were about one foot wide.

Mine safety engineers are routinely able to easily measure stress fields because they have access from inside the tunnels. They collect this information in order to predict possible tunnel wall spalling or collapse. They understand that excess stresses will contribute to dangerous instabilities. Such stresses are useful for our purposes here because they create nonlinearities in the surrounding rock that will produce acoustic heterodynes of fundamentals illuminating them.

Richard H. Burns, et al., describes monitoring a radar radio receiver for a delayed difference frequency signal generated by an object down range that has nonlinear electrical characteristics in response to having itself being illuminated with a plurality of electromagnetic signals. U.S. Pat. No. 8,275,572, issued Sep. 25, 2012. Such appears to be very useful above ground and to find shallow buried landmines. FIG. 2. Collimated beams of millimeter wave electromagnetic signals are directed to surface targets. Frequencies of 90.5 GHz and 91.5 GHz are mentioned which will produce a delayed difference frequency signal of 1.0 GHz. Burns defines nonlinear electrical characteristic as being when current does not have a linear relationship with voltage.

Such conventional technology is concerned with detecting point sources from discrete target objects at the surface like landmines. Tomographic imaging is not really useful nor are 3D images. The millimeter waves will not penetrate the surface very far and are quickly attenuated. The system would not be useful to find ordinary tunnels. The system also depends on the down range targets having electronic or other electrically nonlinear manmade components within.

Long ago experiments were conducted to see if electromagnetic radar waves could be used as a means of probing through solids. What was realized was that millimeter radar wave speeds and amplitudes varied drastically from one solid material to another as a function of distance. The velocity and absorption characteristics of radar waves are strongly dependent on media conductivity. Radar waves penetrate less and reflect more as conductivity increases. As a consequence, clays and other natural materials, layers, and deposits with high conductivities act as efficient barriers to electromagnetic signal beams trying to penetrate deep into the earth.

Acoustics is the study of time-varying deformations, or vibrations in elastic media. Electro-magnetic phenomenon is very different. Acoustic waves are well known to be able to travel long distances through rocks, soils, clays and other overburdens. It appears then that electromagnetic radar techniques could be translated into their acoustic sonar equivalents and used to find deeply buried tunnels.

### SUMMARY OF THE INVENTION

Briefly, ground-penetrating tunnel-detecting active sonar embodiments of the present invention launch two different monotonic acoustic beams down into the ground from the surface. If there are any tunnels in the ground below, the tunnels will be naturally enveloped in a tubular sheath of stress fields caused by lithostatic and hydrostatic pressures working against the emptiness inside the run of the tunnel. When the two separate monotonic acoustic waves arrive at the stress fields, they will mix and produce a frequency difference heterodyne. This is due to the inherent pressure nonlinearities in the solid medias subjected to stress gradients. An acoustic vector sensor on the surface nearby is used listen. Any sonar returns are bandpass filtered so only an acoustic frequency difference heterodyne can pass through. The receiver measures both the scalar (amplitude) and vector (direction) values. The original two different monotonic acoustic beams at higher frequencies are rejected.

The existence of a tunnel is revealed by the return of acoustic frequency difference heterodynes all coming from a more-or-less horizontal line of phase-delayed sources and directions. These phase differences can be derived from the vector values provided by the acoustic vector sensor. Three or more acoustic vector sensors on the surface can be used effectively to provide triangulations down to the tunnel to better estimate the tunnel track.

These and other objects and advantages of the present invention will no doubt become obvious to those of ordinary skill in the art after having read the following detailed description of the preferred embodiments which are illustrated in the various drawing figures.

### IN THE DRAWINGS

FIG. 1 is a cross sectional diagram of an underground tunnel and the surface above, and shows the placement of sonar equipment embodiments of the present invention;

FIG. 2 is a functional block diagram of a ground-penetrating tunnel-detecting active sonar embodiment of the present invention similar to the sonar equipment shown in FIG. 1;

FIG. 3 is a schematic diagram representing how F1 and F2 acoustic tones from acoustic vibrators will both mix, reflect and continue through first and second layers of non-linearity in an overburden in the ground; and

FIG. 4 is a cross sectional diagram of the earth and a well bore showing the relative positions of surface transmitters, receivers, and deep stress fields capable of returning acoustic heterodynes.

### DETAILED DESCRIPTION OF THE PREFERRED EMBODIMENT

Embodiments of the present invention find underground tunnels indirectly by imaging the long, tubular, skin-like stress fields that surround them. Ordinarily lithostatic and hydrostatic pressures will transmit through solids without causing much in the way of pressure gradient ridges unless there are cracks or voids in the solids. Tunnels represent rather large voids with substantial cross sections, and will track for long distances more or less horizontally at the same depths. The stress fields associated with tunnels are relatively substantial and extensive as remote sensed from the surface, and they increase in intensity with their depth because of proportionally increasing lithostatic and hydrostatic pressures.

It just so happens that acoustic waves travel through solid elastic media as pressure variations and will heterodyne two or more tones mix when passing through rock stressed by pressure gradients. Lithostatic and hydrostatic loads and stress in rock, concrete, and other solid deposits can build stress gradients and induce nonlinearities near underground openings. Nonlinear elastic media behavior in rocks is evidenced by deviations from Hooke's law in stress-strain measurements. Such behavior is usually associated with nearby cracks, microfractures, grain joints, and other mechanical defects.

Substantial stress gradients produce anisotropic characteristics in rock that will affect how acoustic waves travel through them. Tunnels and boreholes in the earth are naturally surrounded by stress fields in the supporting, surrounding media and the stresses tend to concentrate tightly in an adjoining tubular skin and focus at any corners and arches.

The determination of the initial stress patterns in rock masses is an important problem in engineering rock mechanics. It is also an important basis for the stability analysis of the rock surrounding underground openings, high rock slopes, arch dam shoulders, dam foundations, and the study of reservoir induced earthquakes. Ma Qichao, Department of Hydraulic Engineering, Tianjin University, published a paper on the subject titled, “The Cause of Formation of the Initial Stress Field in Engineering Rock masses and the Rule of Stress Distribution in the Field”, Chinese Journal of Rock Mechanics and Engineering, 1986-04.

Researchers have generally identified that stress fields inherently surround even well bores and rectangular tunnels. See, Investigation Study of the Stress Field Surrounding a Well Bore and a Rectangular Tunnel, by Biao Qiu and Yi Luo of the Department of Mining Engineering, West Virginia University, published as Stress Fields around Underground Openings, 2011. More often than not, the conventional concerns about the stress fields surrounding boreholes and tunnels is that such stresses can cause breakouts, fragment spalling, and other failures.

Tunnels and boreholes excavated into natural media will consequently fashion nonlinear stress fields that self-organize to surround the introduced void. The logarithmic pressure field distribution in a one-dimensional radial distance from a circular locus of points with radius (R_{c}) and pressure (P_{c}) to a concentric well bore with effective radius (r_{b}) and face pressure(P_{b}) can be represented by,

$$P ( r ) - {P}_{c} = \frac{{P}_{b} - {P}_{c}}{1 n ( \frac{{R}_{c}}{{r}_{b}} )} In ( \frac{{R}_{c}}{r} ) .$$

The natural logarithm (ln) power series expansion is mathematically given by,

$$Ln ( 1 + x ) = x - \frac{{x}^{2}}{2} + \frac{{x}^{3}}{3} - \frac{{x}^{4}}{4} + \frac{{x}^{5}}{5} … .$$

A narrow cylindrical band nearest a borehole experiences most of the pressure differentials. For example, R_{c}≈100 m, and r_{b}≈0.1 m, more than one-third of the pressure differential occurs across the one meter nearest to the borehole core. More than one-half of the pressure differential occurs across a zone with a radius of R_{c}≈3 m. The situation is even more pronounced for boreholes with smaller radii, r_{b}.

In general, the stress field can be represented by a Taylor series expansion. When two or more sinusoidal seismic S (slow traverse) waves, seismic P (fast longitudinal) waves, or acoustic frequency signals travel along a refraction path crossing through a nonlinear stress field, the heterodyne of the two signals generates at least a sum and difference frequency signal given by

\hat{f}=nf₁±mf₂.

When the stress fields follow a square law, the best product frequencies \hat{f}are predominately the upper heterodyne sum and the lower heterodyne difference frequency. The magnitudes of the signals generated will depend on the coefficient of the power series expansion.

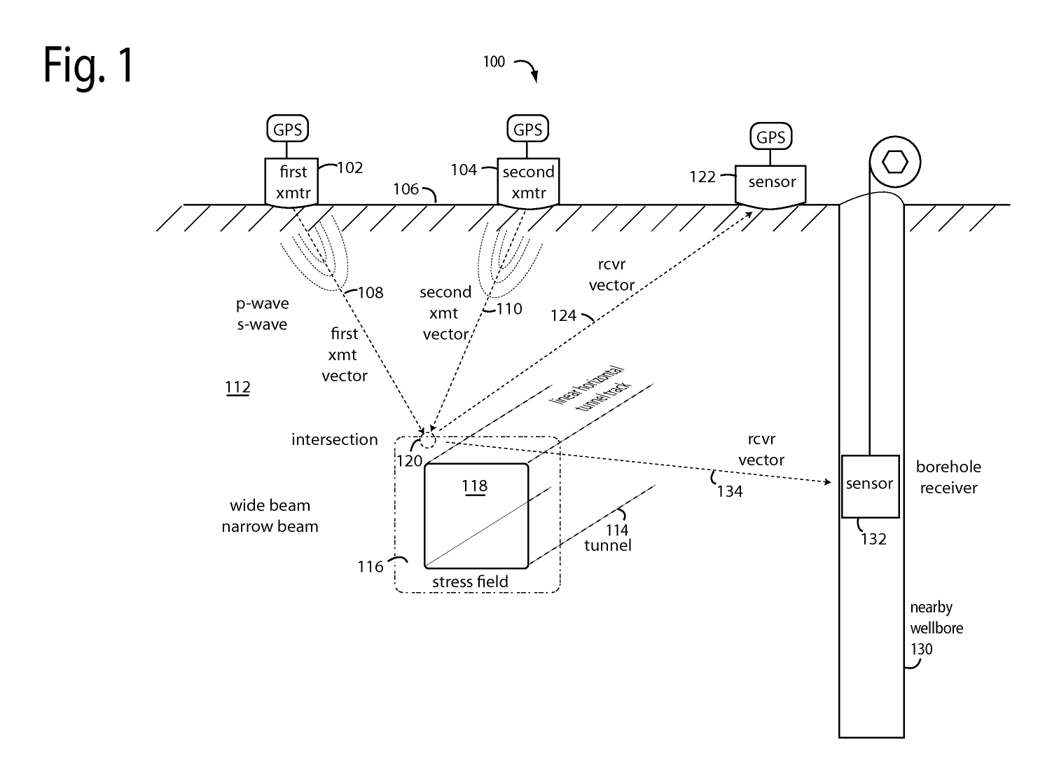

FIG. 1 represents a ground-penetrating tunnel-detecting active sonar embodiment of the present invention, and is referred to herein by the general reference numeral 100. At least two acoustic transmitters 102 and 104 are placed on a ground surface 106 to launch two different monotonic acoustic beams 108 and 110 down into the ground 112 from the surface. Sound waves propagate through solid materials as localized pressure changes. The beam transmissions can be configured to be continuous or periodically pinged. Synchronous detection can be used to advantage if the two transmissions are phase locked, as would be possible if a frequency synthesizer were employed.

There are a number of technical ways to generate strong, monotonic acoustic waves. These range from mechanical tuning forks to stacks of piezoelectric wafers arranged to stretch and compress a metal frame and diaphragm. A new class of in-water sonar transducer includes a directional “dogbone” flextensional transducer that generates cardioid beams, and could be used to replace dual line directional arrays. Such new class increases the front-to-back output ratio by greater than 20-dB.

If there are any tunnels 114 in the ground below, the tunnels 114 will be naturally enveloped in a tubular sheath 116 of stress fields caused by substantial lithostatic and hydrostatic pressures working to collapse the open voids 118 inside the run of the tunnel. See, “In situ and induced stresses”, www.rocscience.com, Rocscience Inc. Toronto, Ontario.

The two monotonic acoustic waves arriving at the tubular sheath 116 in beams 108 and 110 will mix at their intersections in tubular sheath 116, for example, intersection 120. A frequency difference heterodyne will be produced at such intersections due to the inherent nonlinearities of solid medias subjected to stress gradients. In practice, there will be many intersections 120 all along the illuminated sides of tubular sheath 116, limited principally by the beam widths of the two different monotonic acoustic beams 108 and 110.

An acoustic vector sensor 122 on the surface nearby is used to sense any heterodynes arriving on several vectors 124. Such can be implemented as a standoff device, and even as an array, using lasers to detect ground vibrations. The heterodynes from underground will appear to come from a line or belt of intersections 120 that correspond to the run of tunnel 114. Acoustic vector sensor 122 includes a filter to bandpass through only the acoustic frequency difference heterodyne. The two original monotonic frequencies in acoustic beams 108 and 110 are rejected. Acoustic vector sensor 122 provides a primary means to measure both the scalar (amplitude) and vector (direction) values of the heterodynes received.

The existence of any tunnel 114 is revealed in the return of the acoustic frequency difference heterodyne coming from a more-or-less horizontal line of phase-delayed sources, as derived from the vector values provided by the acoustic vector sensor 124. Three or more acoustic sensors without vector capabilities could instead be deployed on the surface in an array to enable phase computed triangulations down to the tunnel 114 to better estimate its track.

If there are any boreholes 130 available nearby, remote sensing instruments could be lowered down inside them. For example, an acoustic vector sensor 132 can be used to receive heterodynes arriving on a vector 134. Alternatively, acoustic transmitters can be placed down within borehole 130 to launch monotonic acoustic beams sideways into the ground 112.

It is important to know the navigational X-Y-Z positions of each of two acoustic transmitters 102 and 104, and acoustic vector sensors 122 and 132. The positions can be surveyed or computed in realtime by GPS navigation receivers, e.g., GPS 140-142. The use of GPS navigation receivers permits the two acoustic transmitters 102 and 104, and acoustic vector sensors 122 and 132, to be rapidly repositioned by field personnel to improve their vantage points. Vehicle mounting would be advantageous.

Heterodyning is generally a radio signal processing technique in which new frequencies, specifically the sum and difference frequencies (F1+F2, |F1−F2|), are generated by combining two frequencies (F1, F2) in a mixer. EH Armstrong used this phenomenon to great effect when he developed the first super-heterodyne radio receivers.

The principal characteristic of mixers and why they can mix is that they are nonlinear. Linear circuits will not produce heterodynes. The most common nonlinear electronic devices are vacuum tubes, transistors, and diodes.

An acoustic “beat” represents the interference between two sounds of slightly different frequencies or harmonic intervals. It is observable as periodic variations in volume with a rate representing the difference between the two original frequencies. Beats can readily be recognized when tuning musical instruments. When a note is tuned close to another in pitch but not identical phase, the difference in their frequencies generates a slowly varying beat. The volume varies like in a tremolo as the sounds alternately interfere constructively and destructively. As the two tones approach agreement, the beats seem to slow down and even stop.

Embodiments of the present invention avoid producing acoustic beatings, and strictly bandpass through only the heterodynes.

Acoustic transducers made from piezoelectric ceramic cylinders usually exploit the breathing or omnidirectional (omni) mode of vibration.

Sandor Holly, et al., describe a comparable radar in U.S. Pat. No. 8,035,550, issued Oct. 11, 2011, and titled, Unbalanced Nonlinear Radar. (Holly '550) Their device sends out a pair of radio frequency beams in which a difference frequency can provide a recognizable radar return. The military targets they are interested in have electronic circuits with nonlinear characteristics that can heterodyne strong radio waves together and radio emit them. Or the intensity of the mix in the nonlinear components is so overwhelming as to literally cook the target and disable or destroy it.

Method and apparatus for using nonlinear ground penetrating radar to detect objects located in the ground, U.S. Pat. No. 8,289,201 describes detecting objects located underground. A detection system finds underground objects with nonlinear electrical characteristics using a transmitter, a receiver, and a processor. A pair of first and second frequency radio frequency signals are pulsed into the ground. The receiver monitors for a response radio frequency signal having a frequency equal to the difference in frequency between the first and second frequencies. Such a response can be produced by signal mixing in an object with nonlinear conductive characteristics. The radar processor announces when a response radio frequency signal is detected by the receiver.

The useful range of audio tones is limited to a frequency maximum of about 14-kHz, since soundwaves above that are highly attenuated by the earth and will not travel more than a few yards deep. The objective is to locate any deeply buried boreholes and/or tunnels. The pressures cause by the overburden will naturally cause stresses to develop in the solid materials immediately surrounding the boreholes and tunnels. Such overburden or lithostatic pressure imposes stresses proportional to the weight of overlying materials, for example:

p(z)=p₀+g [symbol] ρ(z)dz

where, ρ(z) is the density of the overlying rock at depth z and g is the acceleration due to gravity, p₀ is the datum pressure, like the pressure at the surface. The depths involved here are a very small fraction of the Earth's radius, so “g” is placed outside of the integral for most near-surface applications.

Most of the acoustic heterodynes arriving and being measured at the receiver are assumed to be the work of nonlinearities and stresses in the underground area of search that naturally surround and outline tunnels and/or boreholes. Other anomalies and computational idiosyncrasies will produce image artifacts that will need to be ignored or scrubbed.

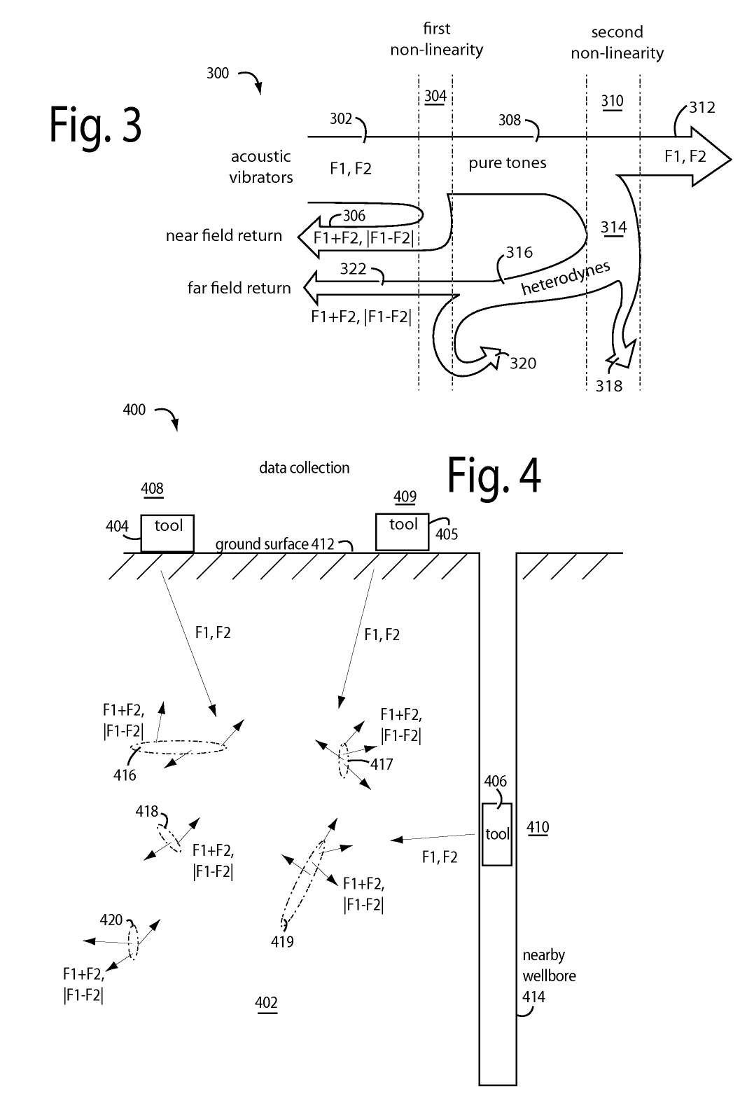

Receiver geophones can be built with magnetic wire coils surrounding a permanent magnetic. The coil is mounted to an Earth contact plate. The mounting configuration can be on three orthogonal axes. The media movement along each axis generates an electromotive force (EMF) voltage measured by instruments. The transmitter may be a piezoelectric ceramic radiator driven by a series of short time domain pulses that are synchronized to a direct digital synthesizer and controllable in frequency steps from 3-kHz to 30-kHz, which receives the spectra components including the transmitted frequencies ω₁ and ω₂ and the nonlinear stress field heterodyne frequencies. Each of the frequency components may be a unique spectrum for each individual source. The received heterodyne signals can be re-heterodyned in electronic circuits to create a common intermediate frequency enabled by a detection process described in FIG. 3-22. The path range can be determined by varying the modulation frequency.

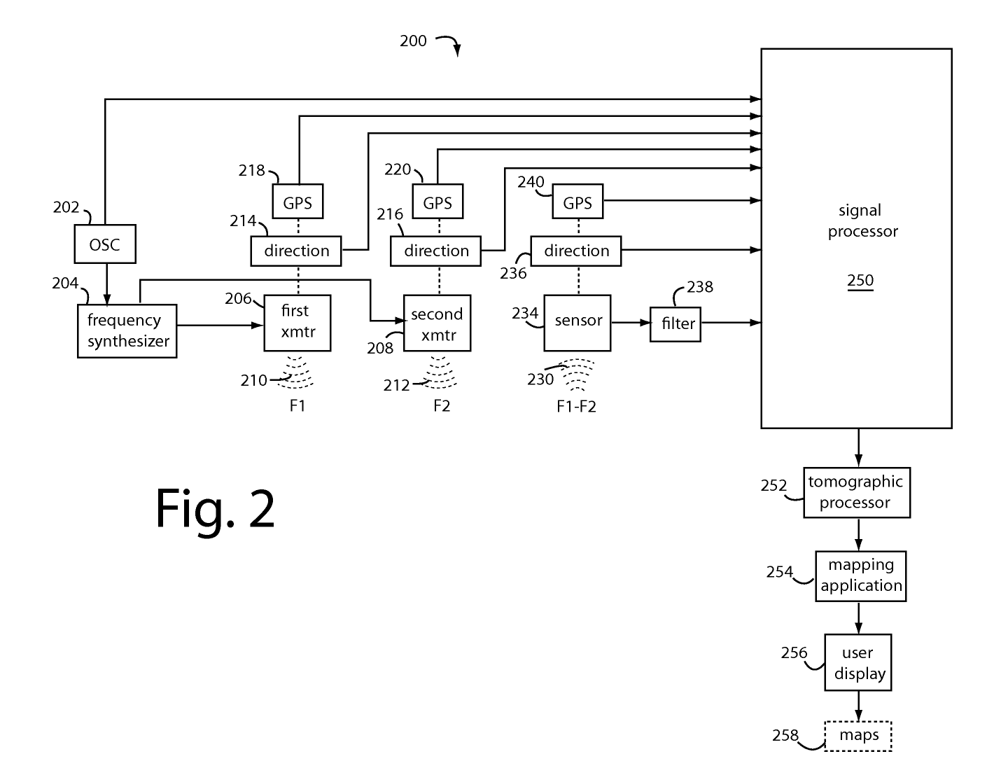

FIG. 2 represents a ground-penetrating tunnel-detecting active sonar embodiment of the present invention, and is referred to herein by general reference 200. Sonar 200 comprises an oscillator 202 that provides overall synchronization of transmitted signals and their detection. A frequency synthesizer 204 outputs two phase locked acoustic frequencies F1 and F2 to a first acoustic transmitter 206 and a second acoustic transmitter 208. These respectively output an F1-soundwave 210 and an F2-soundwave 212 to be pressed into the ground from the surface.

The launching vectors of F1-soundwave 210 and F2-soundwave 212 into the ground from the surface are controlled/reported by direction transducers 214 and 216. The X-Y-Z navigation positions of the first second acoustic transmitters 206 and 208 are determined and reported by GPS units 218 and 220.

The receiving vector of an F1-F2 sound heterodyne 230 is sensed by an acoustic vector sensor 232 and reported by a direction transducer 234. A filter 238 removes any F1 or F2 components. The X-Y-Z navigation position of acoustic vector sensor 232 is determined and reported by GPS unit 240.

A signal processor 250, such as can be implemented with field programmable gate arrays (FPGA), is used to compute the three dimensional underground source locations of F1-F2 sound heterodyne 230. It further fits these computations to models of underground tunnels for graphical renditions of them for users. The signal processor 250 more or less produces raw computational data that would be hard for field personnel to interpret or put to use. So a tomographic processor 252 is included to take such data to build three dimensional images for graphical user display.

Measurements from peripheral sensors placed around objects can reveal the nature and distribution of components hidden within a sensing zone. Many tomographic techniques are concerned with abstracting information to form a cross sectional image. Computer-aided tomography is a technique for providing a two-dimensional cross-sectional view of a three-dimensional object through the digital processing of many one-dimensional views (or projections) taken at different look directions.

In acoustic reflection tomography, insonifying the object and then recording the backscattered signal provides the projection information for a given look direction or aspect angle. Processing the projection information for all possible aspect angles enables an image to be reconstructed that represents the two-dimensional spatial distribution of the object's acoustic reflectivity function when projected on the imaging plane. The shape of an idealized object, which is an elliptical cylinder, is reconstructed by applying standard back projection, Radon transform inversion (using both convolution and filtered back projections), and direct Fourier inversion to simulated projection data. The relative merits of the various reconstruction algorithms are assessed and the resulting shape estimates compared. For bandpass sonar data, however, the wave number components of the acoustic reflectivity function that are outside the passband are absent. This leads to the consideration of image reconstruction for bandpass data. Tomographic image reconstruction is applied to real data collected with an ultra-wideband sonar transducer to form high-resolution acoustic images of various underwater objects when the sonar and object are widely separated. A full-waveform three dimensional tomography algorithm is applied by a graphics processor to the collected and logged data to generate maps and profiles of objects beneath the ground which are interpreted to have produced the acoustic heterodynes.

FIG. 3 represents the many paths, reflections, and mixing that can occur when pairs of acoustic monotones are launched from the ground surface into the ground below. An acoustic transmission 302 comprising two monotones, F1 and F2, is launched from an air environment into a solid media. The solid media will have a stress field at this first interface causing a first nonlinearity 304. Monotones F1 and F2 will mix and produce a near-field heterodyne return 306. (Monotones F1 and F2 also individually reflect but are filtered out.) A remainder 308 of the energy of the original F1 and F2 tones will proceed deeper, e.g., to a second interface of the solid media with the void of a tunnel or borehole causing a second nonlinearity 310.

A remainder 312 of the energy of the original F1 and F2 tones will proceed on. But a portion 314 that is in proportion to the magnitude and severity of second nonlinearity 310 will be returned as heterodynes 316. (Monotones F1 and F2 also individually reflect but are filtered out.) Some will simply dissipate as losses 318. More losses 320 will occur at the first nonlinearity 304. A relatively weak and diminished far field heterodyne return 322 will get back. The near field heterodyne return 306 can be so strong and the far field heterodyne return 322 so faint, that detecting and using the information can be impossible or quite challenging. Embodiments of the present invention therefore use the Bausov method described by Stolarczyk, et al., in U.S. Pat. No. 7,656,342, to suppress the near field heterodyne return 306.

FIG. 4 represents a situation 400 in which an underground area 402 targeted for mining needs to be stabilized. Coal and other deposits can be rifled with cracks, fissures, and paleo-channels that can make mining through them very dangerous. The techniques and equipment described in FIG. 1 can be usefully adapted to locate, characterize, and map the more serious of these faults. Tools 404-406 are moved to positions 408-410 on a ground surface 412 or a wellbore 414. Acoustic waves are transmitted, received, their signals analyzed, data logged, and information accumulated.

Each fault is assumed to be enveloped in a stress field 416-420 that manifests as a nonlinearity able to mix acoustic tones and radiate heterodynes. Stress-fields 416-420 will mix and produce sum (F1+F2) and difference (|F1−F2|) heterodynes when pure audio tones (F1, F2) reach each of them respectively. Their corresponding times of travel and relative attenuation as seen by a receiver can be used to reveal the likely locations of the stress-fields 416-420 that produced them. Embodiments of the present invention interpret such heterodynes as having come from underground cracks, fissures, and unconsolidated sediments or semi-consolidated sedimentary rocks deposited in ancient, long-inactive river and stream channels, e.g., paleo-channels.

Tools 404-406 include at least one acoustic receiver amongst them able to filter through the heterodynes and measure the relative times of arrival and attenuation. These measurements are collected in real-time for use in post processing, e.g., as in FIG. 2.

Vector acoustic sensors, or acoustic intensity sensors, can determine the direction in which sound waves are traveling. They use measurements made from a single point in space. Individual hydrophones are not sensitive to direction, so hydrophone arrays made up of a number of hydrophones are needed to determine the direction in which a sound wave is moving.

Particle motion in soundwaves is described by displacement, velocity, and acceleration. These three quantities are vectors, because each has a direction as well as a magnitude. Vector sensors measure one of these vector quantities together with pressure. (Some vector sensors actually measure pressure gradient, which is proportional to acceleration, rather than particle motion itself.) For example, a vector sensor can be created by appropriately combining two geophones, which generate electric signals proportional to the particle velocity in a sound wave, and a standard hydrophone, which measures pressure.

Hydrophones are the most common underwater acoustic sensors, but vector sensors have been used in U.S. Navy DIFAR (Directional Frequency Analysis and Recording] AN/SSQ-53 sonobuoys for many years. The DIFAR sensor uses an omnidirectional hydrophone to measures pressure, and two particle motion sensors mounted at right angles to each other to measure the horizontal components of the sound wave arrival. All three sensors are co-located in a single package that has nearly the same density as seawater so that the package moves with the sound wave in the same way as the surrounding water particles.

DIFAR sensors are most sensitive to signals arriving from a specified horizontal direction, while being less sensitive to signals arriving from other directions. The beam pattern, which describes the sensitivity of a directional receiving system (either an array of sensors or a single vector sensor) to incoming signals as a function of heading or direction, has the shape of a cardioid when a conventional beamforming approach (equal weighting for all components) is used with single vector sensor data.

The sensitivity of a conventional vector sensor varies from a maximum for signals arriving from the direction to which the sensor is steered (0° here) to a minimum for signals arriving from the opposite direction (180° here).

In addition to determining the direction in which a sound wave is traveling, the DIFAR sensors also improve the signal-to-noise (SNR) ratio by rejecting noise arriving from directions other than the direction from which the signals of interest are arriving.

Multiple concurrent sound sources can happen within dry and reverberant environments. Earlier sound localization techniques used microphone arrays to estimate the acoustic intensity vector of a source by measuring the pressure differences between widely separated omnidirectional microphones. This technique does not work well when multiple concurrent sound sources are present. The techniques explored in research use novel acoustic vector sensor type microphones which measure the acoustic intensity vector via one pressure sensor and three differential microphones, all collocated. The performance of these microphones was evaluated and used as a basis for acoustic vector array configurations. The performance of the arrays were measured by how well they localize multiple sources within different environments. The same microphone array can also be used to beamform to a particular sound source, e.g., to acoustically separate sources from surrounding noise. An important application is multi-speaker voice transcription where the key speaker in a room needs to be found and then separated from opposing speakers/noise so that an accurate transcription can be generated by automatic speech recognition software.

New, single-crystal piezoelectric materials now make it possible to build smaller vector sensors without sacrificing sensitivity. For example, three-dimensional (3-D) vector sensors that use separate single crystals to measure acceleration and a hydrophone to measure pressure will fit in a housing 0.8 inches in diameter, and 3.125 inches in length.

These new 3-D vector sensors provide more flexibility than the older 2-D sensors since they can make measurements in any orientation in space. Miniaturization allows for new applications as well as deployment approaches to reduce motion-induced self-noise, a source of noise contamination that has impeded wider use of acoustic vector sensor technology.

FalconView, by Georgia Tech Professional Education, is a PC-based mapping application that can be advantageously included to provide meaningful and informative user displays. See, www.falconview.org.

FalconView™ is a non-proprietary, government off-the-shelf (GOTS) application for analyzing and displaying geographical data crucial to warfighters. Its ease of use and wide variety of applications have made it the system of choice for the warfighter and the standard for data interchange in Iraq and Afghanistan. FalconView is a mission-planning, mapping application for the PC, which displays various types of maps and geo-referenced overlays. It supports the display of aeronautical charts, satellite images and elevation maps. FalconView also supports a large number of overlay types that can be displayed over any map background. The current overlay set is targeted toward military mission planning users and is oriented towards aviators and aviation support personnel. This application supports various types of overlays on top of the base map. These overlays can be of two types: static or file. Static overlays are single-instance overlays. This means there can only be one of them, and it is either on (opened) or off (closed). File overlays are multiple-instance overlays. This means there can be any number of them, and each one is stored in a separate file.

The present invention is hard to categorize, it's not exactly a radar and not exactly a sonar. At least not in the traditional sense. Its transmitters are acoustic and not radio, they transmit two pure tone carriers in tandem that are not sidebands, and yet its receiver is not tuned to select any reflections of either of the originally transmitted soundwaves.

Our targets of interest are long, linear, horizontal, underground openings. These are naturally surrounded by stress fields generated by lithostatic pressures. When there aren't any underground tunnels, boreholes, or other openings present, there won't be any significant stress fields of interest.

However, if such stress fields are present, they will induce non-linearities in the overburden that make the solid materials capable of mixing acoustic carriers and producing acoustic heterodynes. Our acoustic receiver then is tuned to select only the tones calculated for the heterodynes and not the original carriers.

Embodiments of the present invention do not work this way, the heterodynes looked for at the receiver are not reflections. They are like photoluminescence where the illumination with one kind of energy causes the photons to be absorbed, and thus stimulates the emission of a second kind of light energy. Such as UV into visible light. If the photo-luminescent material is absent, there will be no observation possible of the second kind of light energy.

The range distance can be calculated from the time the acoustic carriers were launched and the heterodynes received, and the speed of sound propagation. Or, by reading the vectors and calculating a triangulation.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

What is claimed is:

1. An acoustic heterodyne radar for locating deeply buried boreholes and tunnels by virtue of the lithostatic stress fields that envelope them, comprising:
a portable tool configured to be serially re-locatable at diverse locations on a ground surface and inside a well bore vantage point, and having a pair of acoustic radiators each configured as tone transmitters to launch respective ones of simultaneous pairs of pure audio tones (F1, F2) without sidebands into an underground area of search and without mixing F1 with F2 such as to produce heterodynes when launched;
an acoustic tone receiver and filter included in the portable tool and configured to bandpass through only selected heterodynes of F1 mixed with F2; and
a measurements device connected to the acoustic tone receiver and configured to measure and collect the relative times of arrival and attenuation of any said selected heterodynes;
a processor configured to tomographically compute from collected measurements the underground origination points of said selected heterodynes into three dimensional images of boreholes and tunnels enveloped by stress fields capable of the non-linear mixing of F1 with F2 to produce said selected heterodynes.

2. The acoustic heterodyne radar of claim 1, further comprising:
a computed tomography processor connected and configured to interpret a receipt of said selected heterodynes as having come from cracks, fissures, and/or paleo-channels situated in said underground area of search;
wherein, estimates of the locations of said cracks, fissures, and/or paleo-channels constitute an information output of the radar.

3. The acoustic heterodyne radar of claim 2, further comprising:
a ground stabilization grout or cement configured to be injected in the earth at a position dependent on location estimate information output by the radar.

4. The acoustic heterodyne radar of claim 1, further comprising:
a Bausov mechanism configured to suppress any near field heterodyne signals wherein sensitivity is improved for any far field heterodyne signals.

5. A method for acoustic heterodyne radar, comprising:
launching simultaneous pairs of pure audio tones (F1, F2) into an underground area of search respectively with a pair of acoustic radiators;
bandpassing through only selected heterodynes from said underground area of search with an acoustic receiver and filter;
measuring and collecting the relative times of arrival and attenuation of any selected heterodynes with a measurements device connected to the acoustic receiver;
tomographically computing the underground origination points of said selected heterodynes from collected measurements into three dimensional images of boreholes and tunnels enveloped by stress fields capable of the non-linear mixing of F1 with F2 to produce said selected heterodynes.

6. The method of claim 5, further comprising:
identifying and estimating the locations of any previously unknown boreholes and/or tunnels in said underground area of search by interpreting the receipt of heterodynes as the result of non-linear mixing in the stress fields that envelope underground openings.

7. The method of claim 5, further comprising:
identifying and estimating the locations of any cracks, fissures, and/or paleo-channels in said underground area of search by interpreting the receipt of heterodynes as the result of non-linear mixing in the stress fields that envelope underground openings.

8. The method of claim 5, further comprising:
identifying and estimating the extent and intensity of any stresses surrounding already known boreholes and/or tunnels in said underground area of search by applying computed full waveform three dimensional tomography in a post processing.

9. A ground-penetrating, tunnel-detecting active sonar, comprising:
a first directional sound transmitter configured to output a first acoustic soundwave having a first monotonic acoustic frequency from a ground surface into a ground below;
a second directional sound transmitter configured to output a second acoustic soundwave having a second monotonic acoustic frequency from said ground surface into the ground below;
a directional sound receiver configured to receive and bandpass acoustic soundwaves having a third monotonic acoustic frequency equal to the difference between the first and second monotonic acoustic frequencies, and arriving at said ground surface from the ground below;
a signal processor connected to the directional sound receiver and configured to interpret the reception of any acoustic soundwaves having said third monotonic acoustic frequency as representing a painting of an underground tunnel having a particular depth, cross section, and horizontal track beneath said ground surface; and
a display screen connected to the processor and configured to graphically represent any such underground tunnel on a representative map according to said particular depth, cross section, and horizontal track beneath said ground surface;
wherein, said third monotonic acoustic frequency represents a nonlinear mix of said first and second monotonic acoustic frequencies in a stress concentration zone in the ground below.

10. The ground-penetrating, tunnel-detecting active sonar of claim 9, further comprising:
a first aiming device configured to direct the first directional sound transmitter along a first vector from said ground surface into said ground below;
a second aiming device configured to direct the second directional sound transmitter along a second vector from said ground surface into said ground below to intersect with the first vector; and
a data report describing the first and second vectors and an estimated location of their intersections connected to the processor and for refining a graphical depiction of the particular depth, cross section, and horizontal track beneath said ground surface of any underground tunnels on said representative map.

11. The ground-penetrating, tunnel-detecting active sonar of claim 10, further comprising:
a receiver aiming device configured to direct the directional sound receiver along a third vector from said ground surface into said ground below to an intersection of the first and second vectors as derived from the data report, and for refining said graphical depiction of the particular depth, cross section, and horizontal track beneath said ground surface of said underground tunnels on said representative map.

12. The ground-penetrating, tunnel-detecting active sonar of claim 10, further comprising:
a tracking device connected to the first and second aiming devices and configured to adjust them so that the calculated intersections of the first and second vectors move virtually along a linear track of an ostensible underground tunnel.

13. The ground-penetrating, tunnel-detecting active sonar of claim 9, further comprising:
a receiver aiming device configured to direct the directional sound receiver along a reception vector from said ground surface into said ground below.

14. The ground-penetrating, tunnel-detecting active sonar of claim 9, further comprising:
an acoustic filter connected to the directional sound receiver and configured to remove signals representing said first and second acoustic soundwaves and any purely acoustic beatings between them, and to pass through only a single frequency heterodyne.
